(19) United States
(12) Patent Application Publication
(10) Pub. No.: US 2026/0299392 A1
(43) Pub. Date: Oct. 1, 2026

(54) LIGHT SOURCE MODULE AND PROJECTION DEVICE

(71) Applicant: Coretronic Corporation, Hsin-Chu (TW)

(72) Inventors: Yi-Hsuang Weng, Hsin-Chu (TW); Jen-Wei Kuo, Hsin-Chu (TW); Chun-Hsin Lu, Hsin-Chu (TW); Wen-Chieh Chung, Hsin-Chu (TW)

(73) Assignee: Coretronic Corporation, Hsin-Chu (TW)

(21) Appl. No.: 19/558,445

(22) Filed: Mar. 6, 2026

(30) Foreign Application Priority Data
Mar. 25, 2025 (CN) 202510353833.4

(51) Int. Cl. G03B 21/20

(52) U.S. Cl. CPC G03B 21/208; G03B 21/2013; G03B 21/2033; G03B 21/2073

(57) ABSTRACT

A light source module configured to provide an illumination beam and including a light emitting module and a light homogenizing module is provided. The light emitting module includes at least one light emitting element. Each of the at least one light emitting element is configured to provide a polarization beam. The light homogenizing module is configured to homogenize the polarization beams, and generate an illumination beam. The light homogenizing module sequentially includes a first microlens array element, a first lens element, a phase adjustment element, a second microlens array element, and a second lens element along a light travelling direction. A projection device including the light source module is also provided.

### CROSS-REFERENCE TO RELATED APPLICATION

This application claims the priority benefit of China application serial no. 202510353833.4, filed on Mar. 25, 2025. The entirety of the above-mentioned patent application is hereby incorporated by reference herein and made a part of this specification.

### BACKGROUND

### Technical Field

The disclosure relates to a light source module and a projection device.

### Description of Related Art

The laser light source has the characteristics of high coherence and wide color gamut, and is one of the light sources commonly used in projectors. However, in the case where light rays generated by the laser light source interfere with each other, a projection image has a speckle distribution with slight brightness changes. The speckles with slight brightness changes seriously affect the comfort of viewing the projection image. In order to reduce such a phenomenon, a movable diffuser is located on the light path, so that the light rays with the same color have different phases. Under the superposition of the speckles with different phases, the projection image appears to be more homogenized, and the comfort of viewing is also improved.

The movable diffuser is usually placed in front of an integrating rod. Considering the requirement of overall volume of the projector, the light rays focus via a lens element to form speckles with smaller sizes. The length of the projector is sacrificed to minimize the size of the movable diffuser, so as to balance between the volume of the projector and the comfort of viewing. When the speckle problem is solved using this method (by adding the movable diffuser), the homogenization effect of the speckle generally improves as the diffusion angle of the diffuser increases. However, as the diffusion angle increases, the etendue of the projector also increases, resulting in limitations on the brightness of the projector.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

According to an embodiment of the disclosure, a light source module is configured to provide an illumination beam, and the light source module includes a light emitting module and a light homogenizing module. The light emitting module includes at least one light emitting element. Each of the at least one light emitting element is configured to provide a polarization beam. The light homogenizing module is configured to homogenize the polarization beam, and generate an illumination beam. The light homogenizing module sequentially includes a first microlens array element, a first lens element, a phase adjustment element, a second microlens array element, and a second lens element along a light travelling direction. The first microlens array element is configured to receive the polarization beam, and homogenize the polarization beam to form multiple first sub-beams. The first lens element is disposed on transmission paths of the first sub-beams and is configured to converge the first sub-beams. After passing through the first lens element, the first sub-beams are converged by the first lens element to form a converging beam. The phase adjustment element is disposed on a transmission path of the converging beam. The converging beam generates multiple sub-converging beams after passing through the phase adjustment element. At least part of the sub-converging beams has a different phase from the converging beam. The second microlens array element is disposed on transmission paths of the sub-converging beams and is configured to homogenize the sub-converging beams to form multiple second sub-beams. The second lens element is disposed on transmission paths of the second sub-beams and is configured to converge the second sub-beams. After passing through the second lens element, the second sub-beams are converged by the second lens element to form the illumination beam.

According to an embodiment of the disclosure, a projection device includes the light source module, a light valve, and a projection lens. The light valve is disposed on a transmission path of the illumination beam and is configured to convert the illumination beam into an image beam. The projection lens is disposed on a transmission path of the image beam and is configured to project the image beam out of the projection device.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The drawings are included to provide a further understanding of the disclosure, and the drawings are incorporated into the specification and constitute a part of the specification. The drawings illustrate embodiments of the disclosure and serve to explain principles of the disclosure together with the description.

FIG. 1 is a schematic diagram of a projection device according to an embodiment of the disclosure.

FIG. 2 is a schematic diagram of a light emitting module according to an embodiment of the disclosure.

FIG. 3 is a schematic diagram of a light emitting module, a first microlens array element, a first lens element, and a phase adjustment element according to an embodiment of the disclosure.

FIG. 4 is a schematic diagram of a phase adjustment element according to an embodiment of the disclosure.

FIG. 5 is a schematic diagram of a phase adjustment element according to another embodiment of the disclosure.

FIG. 6 is a schematic diagram of a phase adjustment element according to yet another embodiment of the disclosure.

### DESCRIPTION OF THE EMBODIMENTS

Reference will now be made in detail to the exemplary embodiments of the disclosure, and examples of the exemplary embodiments are illustrated in the drawings. Wherever possible, the same reference numerals are used in the drawings and the description to refer to the same or similar parts.

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. In addition, for the sake of clarity, each drawing depicts a direction x, a direction y, and a direction z that are perpendicular to each other. The directions x, y, and z are used for illustration and are not used to limit the disclosure. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The disclosure provides a light source module, which may reduce speckles.

The disclosure also provides a projection device, which may provide a projection image with good homogeneity.

Other objectives and advantages of the disclosure may be further understood from the technical features disclosed in the disclosure.

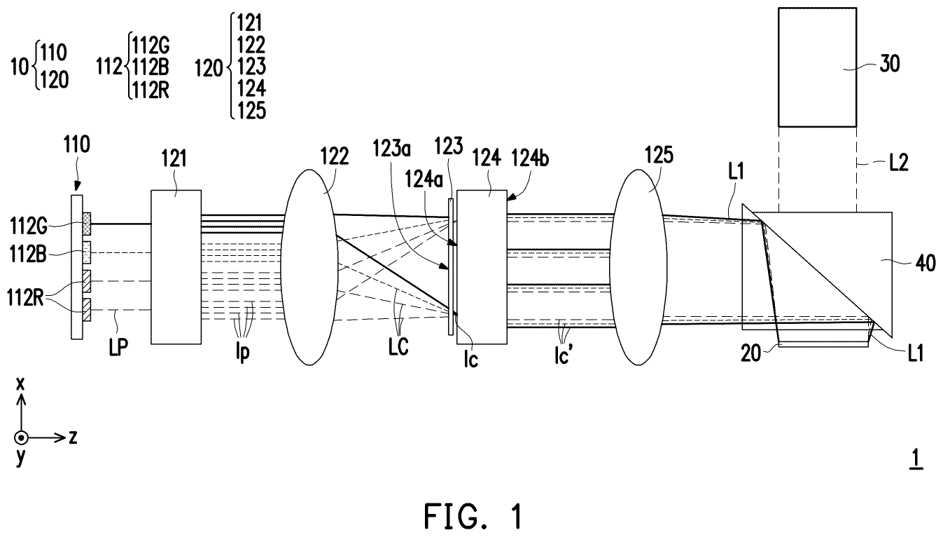

FIG. 1 is a schematic diagram of a projection device according to an embodiment of the disclosure. Please refer to FIG. 1. A projection device 1 includes a light source module 10, a light valve 20, and a projection lens 30. The light source module 10 is configured to provide an illumination beam L1. The light valve 20 is disposed on a transmission path of the illumination beam L1 and is configured to convert the illumination beam L1 into an image beam L2. The projection lens 30 is disposed on a transmission path of the image beam L2 and is configured to project the image beam L2 out of the projection device 1. In some embodiments, the projection device 1 may be a projector, and the light valve 20 may be a reflective light modulator such as a digital micro-mirror device (DMD) and a liquid crystal on silicon (LCOS) panel or a transmissive light modulator such as a transparent liquid crystal panel, an electro-optical modulator, a magneto-optical modulator, and an acousto-optical modulator (AOM), but the disclosure is not limited thereto. The projection lens 30 includes, for example, a combination of one or more optical lenses with refractive power, such as various combinations of non-planar lenses such as a biconcave lens, a biconvex lens, a concave-convex lens, a convex-concave lens, a plano-convex lens, and a plano-concave lens. In other embodiments, the projection lens 30 may further include a planar optical lens to project the image beam L2 to a projection target in a reflective manner. The projection target is, for example, a screen or a wall. The disclosure does not limit the form and the type of the projection lens 30.

In some embodiments, the projection device 1 may further optionally include a prism group 40. The prism group 40 is disposed on a transmission path of the illumination beam L1 between the light source module 10 and the light valve 20. The illumination beam L1 from the light source module 10 enters the prism group 40 and is reflected by the prism group 40 to the light valve 20. The illumination beam L1 is converted into the image beam L2 by the light valve 20 and then transmitted to the projection lens 30 through the prism group 40. For example, in some embodiments, the prism group 40 may be a total internal reflection (TIR) prism group formed by combining two prisms, but the disclosure is not limited thereto.

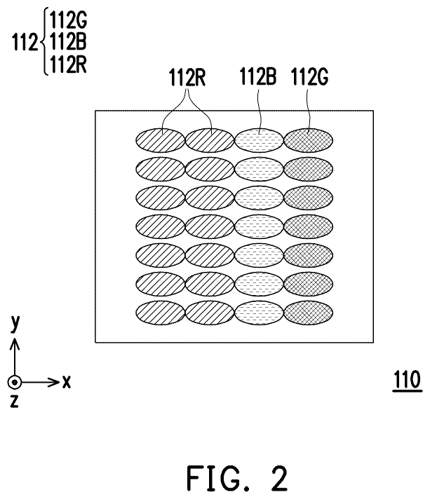

FIG. 2 is a schematic diagram of a light emitting module according to an embodiment of the disclosure. Please refer to FIG. 1 and FIG. 2. The light source module 10 includes a light emitting module 110 and a light homogenizing module 120. The light emitting module 110 includes at least one light emitting element 112. The number of the light emitting element 112 of the light emitting module 110 may be one or more. Each light emitting element 112 is configured to provide a polarization beam LP. In some embodiments, the polarization beam LP is, for example, a linear polarization beam. However, the disclosure is not limited thereto. In other embodiments, the polarization beam LP may also be a circular polarization beam or beams of other polarization types.

In some embodiments, the light emitting element 112 is, for example, a laser diode (LD), but the disclosure is not limited thereto. In some embodiments, the light emitting module 110 may include multiple light emitting elements 112 arranged in an array. In some embodiments, the light emitting elements 112 may include a light emitting element 112R, a light emitting element 112G, and a light emitting element 112B, wherein the light emitting element 112R, the light emitting element 112G, and the light emitting element 112B are configured to emit the polarization beams LP with different colors. In some embodiments, the polarization beams LP respectively emitted by the light emitting element 112R, the light emitting element 112G, and the light emitting element 112B are respectively, for example, a red polarization beam, a green polarization beam, and a blue polarization beam, but the disclosure is not limited thereto. In the embodiment, the light emitting module 110 includes multiple light emitting elements 112 with different colors arranged in a 4*7 array. Specifically, the light emitting module 110 includes two red light emitting elements 112R, one blue light emitting element 112B, and one green light emitting element 112G sequentially arranged along the direction x and 7 light emitting elements 112 with the same color arranged along the direction y, so as to form the 4*7 array. In some embodiments, the array of the light emitting elements 112 with the same color may be assembled into a package, and multiple packages with different colors may guide the polarization beams LP to the light homogenizing module 120 via light combining and/or light splitting elements, but the disclosure is not limited thereto.

Please refer to FIG. 1. The light homogenizing module 120 is configured to homogenize the polarization beam LP and generate the illumination beam L1. The light homogenizing module 120 sequentially includes a first microlens array element 121, a first lens element 122, a phase adjustment element 123, a second microlens array element 124, and a second lens element 125 along a light travelling direction. In some embodiments, the phase adjustment element 123 is a stationary member.

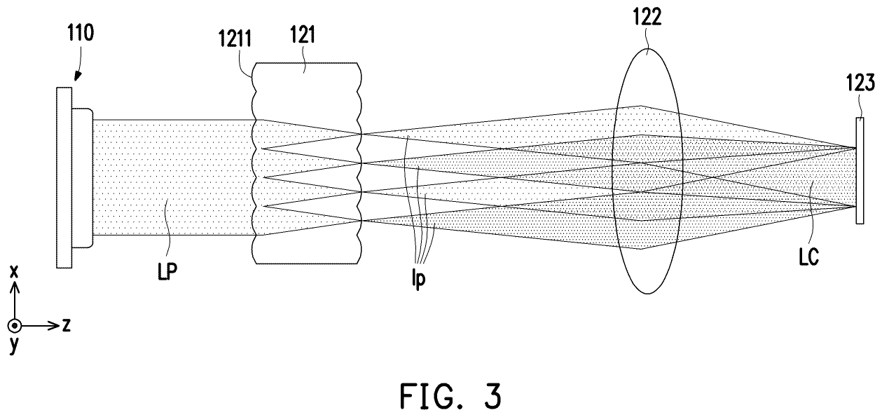

FIG. 3 is a schematic diagram of a light emitting module, a first microlens array element, a first lens element, and a phase adjustment element according to an embodiment of the disclosure. In particular, FIG. 3 shows a detailed light path from the light emitting module 110 to the phase adjustment element 123. Please refer to FIG. 1 and FIG. 3. The first microlens array element 121 is configured to receive the polarization beam LP, and homogenize the polarization beam LP to form multiple first sub-beams lp. The first lens element 122 is disposed on transmission paths of the first sub-beams lp. The first lens element 122 may be a light converging lens and is configured to converge the first sub-beams lp. After passing through the first lens element 122, the first sub-beams lp are converged by the first lens element 122 to form a converging beam LC. The phase adjustment element 123 is disposed on a transmission path of the converging beam LC and is configured to change the phase of at least part of the converging beam LC.

The first microlens array element 121 includes a light incident surface and a light emergent surface opposite to each other. The light incident surface and the light emergent surface respectively include multiple first microlenses 1211. A plane formed by the direction x and the direction y is defined as a reference surface, and the shape of an orthographic projection of each of the first microlenses 1211 on the reference surface is a square or a hexagon. When the polarization beam LP enters the first microlenses 1211 of the first microlens array element 121, the first microlenses 1211 have a homogenizing effect on the polarization beam LP, thereby splitting the polarization beam LP into the first sub-beams lp.

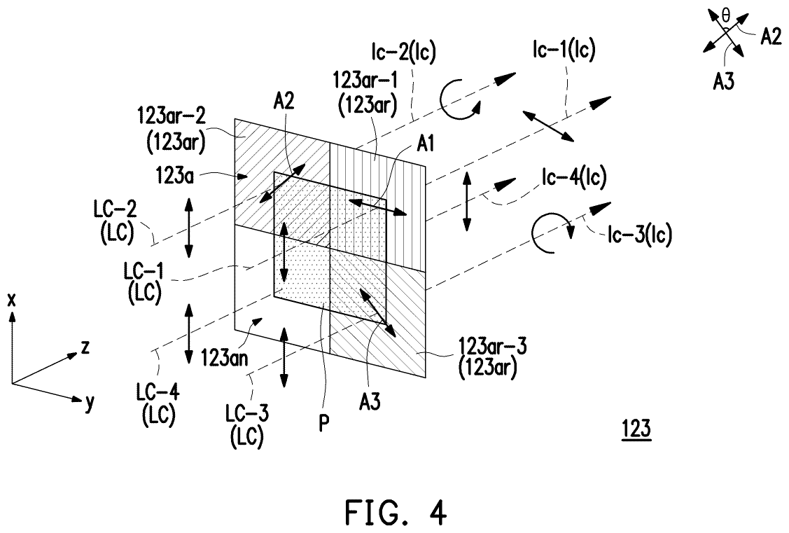

FIG. 4 is a schematic diagram of a phase adjustment element according to an embodiment of the disclosure. Please refer to FIG. 1 and FIG. 4. The converging beam LC generates multiple sub-converging beams lc after passing through the phase adjustment element 123. At least part of the sub-converging beams lc, for example, sub-converging beams lc-1, lc-2, and lc-3, have different phases from the converging beam LC. The second microlens array element 124 is disposed on transmission paths of the sub-converging beams lc (including the sub-converging beams lc-1, lc-2, and lc-3) and is configured to homogenize the sub-converging beams lc to form multiple second sub-beams lc′. The second lens element 125 is disposed on transmission paths of the second sub-beams 1c′ and is configured to converge the second sub-beams 1c′. After passing through the second lens element 125, the second sub-beams lc′ are converged by the second lens element 125 to form the illumination beam L1.

When passing through the first microlens array element 121, the polarization beams LP with different colors and emitted from different positions are split into the first sub-beams lp by the first microlens array element 121. When passing through the first lens element 122, the first sub-beams lp are superimposed by the first lens element 122 to form the converging beam LC. The phase adjustment element 123 is provided at a position where the converging beam LC is formed. After passing through different regions of the phase adjustment element 123, the converging beam LC forms the sub-converging beams lc with different phases. After passing through the second microlens array element 124 and the second lens element 125, the sub-converging beams lc with different phases are split again into multiple different second sub-beams lc′, which are then superimposed to form the illumination beam L1. Since the illumination beam L1 is superimposed from the second sub-beams lc′ with different phases, the second sub-beams lc′ do not easily interfere with each other to form speckles with slight brightness changes, thereby obtaining the projection image with good homogeneity.

It is worth mentioning that the polarization beams LP emitted from different positions of the light emitting module 110 are split into the first sub-beams lp by the first microlens array element 121 when passing through the first microlens array element 121. The first sub-beams lp may form multiple sub-speckles (not shown) on the reference surface. After passing through the first lens element 122, the first sub-beams lp are converged by the first lens element 122 to form the converging beam LC. The converging beam LC may form a speckle P on the reference surface (as shown in FIG. 4). The speckle P may be regarded as being formed by the sub-speckles superimposed. The phase adjustment element 123 is disposed on the transmission path of the converging beam LC, so that the speckle P formed by the converging beam LC may be located on at least part of the phase adjustment element 123. In this way, the position precision requirement of the phase adjustment element 123 may be reduced, thereby increasing the assembly margin.

Please refer to FIG. 1. In some embodiments, the second microlens array element 124 has a light incident surface 124a and a light emergent surface 124b opposite to each other. The light incident surface 124a is configured to allow multiple sub-converging beams 1c to enter. The light incident surface 124a and the light emergent surface 124b respectively include multiple second microlenses (not shown). The shape of an orthographic projection of each of the second microlenses on the reference surface is a rectangle. When the sub-converging beams lc enter the second microlenses of the second microlens array element 124, the second microlenses have a homogenizing effect on the sub-converging beams lc, thereby splitting the sub-converging beams lc into the second sub-beams lc′.

A focal plane of the first lens element 122 may be substantially located on the light incident surface 124a of the second microlens array element 124, and the phase adjustment element 123 is substantially disposed on the light incident surface 124a of the second microlens array element 124. In other words, the phase adjustment element 123 is substantially located on the focal plane of the first lens element 122. However, the disclosure is not limited thereto. In other embodiments, the phase adjustment element 123 may also be disposed adjacent to the focal plane of the first lens element 122. Specifically, in other embodiments, the phase adjustment element 123 is located between the first lens element 122 and the second microlens array element 124, and is disposed close to the light incident surface 124a of the second microlens array element 124 and away from the first lens element 122.

Please refer to FIG. 1 and FIG. 4. In some embodiments, the phase adjustment element 123 has a light incident surface 123a. The light incident surface 123a is configured to allow the converging beam LC to enter. The light incident surface 123a of the phase adjustment element 123 has at least one phase retardation area 123ar. The at least one phase retardation area 123ar is configured to allow at least part of the converging beam LC (for example, converging beams LC-1, LC-2, and LC-3) to enter and retard/delay the phases of at least part of the converging beam LC (that is, the converging beams LC-1, LC-2, and LC-3) to generate at least part of the sub-converging beams LC (for example, the sub-converging beams lc-1, lc-2, and lc-3).

In some embodiments, the number of the at least one phase retardation area 123ar may optionally be multiple. For example, the phase retardation area 123ar includes a first phase retardation area 123ar-1, a second phase retardation area 123ar-2, and a third phase retardation area 123ar-3. The speckle P formed by the converging beam LC on the light incident surface 123a of the phase adjustment element 123 overlaps with at least part of each of the phase retardation areas 123ar (that is, the first phase retardation area 123ar-1, the second phase retardation area 123ar-2, and the third phase retardation area 123ar-3) (that is, the converging beam LC is incident on each phase retardation area 123ar), and the number of the at least part of the sub-converging beams lc generated after the converging beam LC passes through the phase retardation areas 123ar is the same as the number of the phase retardation areas 123ar. For example, in the embodiment, the number of the phase retardation areas 123ar is 3, and the number of the at least part of the sub-converging beams 1c generated after the converging beam LC passes through the phase retardation areas 123ar is also 3.

In some embodiments, the first phase retardation area 123ar-1 and the second phase retardation area 123ar-2 respectively have phase retardation values and fast axis directions A1 and A2, wherein the phase retardation value of the first phase retardation area 123ar-1 is different from the phase retardation value of the second phase retardation area 123ar-2 and/or the fast axis direction A1 of the first phase retardation area 123ar-1 is different from the fast axis direction A2 of the second phase retardation area 123ar-2. In some embodiments, the third phase retardation area 123ar-3 has a phase retardation value and a fast axis direction A3. The phase retardation value of the first phase retardation area 123ar-1 and the phase retardation value of the second phase retardation area 123ar-2 are different, the phase retardation value of the second phase retardation area 123ar-2 and the phase retardation value of the third phase retardation area 123ar-3 are the same, there is an included angle θ between the fast axis direction A2 of the second phase retardation area 123ar-2 and the fast axis direction A3 of the third phase retardation area 123ar-3, and the included angle θ is not 180 degrees. For example, in some embodiments, the first phase retardation area 123ar-1 may be a half-wave plate, the second phase retardation area 123ar-2 may be a quarter-wave plate, the third phase retardation area 123ar-3 may be a quarter-wave plate, and the fast axis direction A2 of the second phase retardation area 123ar-2 is orthogonal to the fast axis direction A3 of the third phase retardation area 123ar-3.

Please refer to FIG. 1 and FIG. 4. In some embodiments, the light incident surface 123a of the phase adjustment element 123 may further optionally have an inactive area 123an configured to allow another part of the converging beam LC (for example, a converging beam LC-4) to enter. The speckle P formed by the converging beam LC on the light incident surface 123a of the phase adjustment element 123 overlaps with at least part of the inactive area 123an. After the another part of the converging beam LC (that is, the converging beam LC-4) passes through the inactive area 123an, the phase does not change. In some embodiments, the inactive area 123an may be a substrate without any phase retardation value, such as but not limited to glass. However, the disclosure is not limited thereto. In other embodiments, the inactive area 123an may also be a hollow portion of the phase adjustment element 123.

Please refer to FIG. 1 and FIG. 4. Through the phase adjustment element 123, at least part of the sub-converging beams lc (that is, the sub-converging beams lc-1, lc-2, and lc-3) and the converging beam LC may have different phases. For example, in some embodiments, when a part of the converging beam LC (that is, the converging beam LC-1) passes through the first phase retardation area 123ar-1, since the first phase retardation area 123ar-1 is a half-wave plate, the phase of the part of the converging beam LC (that is, the converging beam LC-1) may be retarded by π. The converging beam LC-1 forms a part of the sub-converging beam lc (that is, the sub-converging beam lc-1) after passing through the first phase retardation area 123ar-1, the sub-converging beam lc-1 is a linear polarization beam in another direction, and the polarization direction of the sub-converging beam lc-1 is orthogonal to the polarization direction of the original converging beam LC-1. When a part of the converging beam LC (that is, the converging beam LC-2) passes through the second phase retardation area 123ar-2, since the second phase retardation area 123ar-2 is a quarter-wave plate, the phase of the part of the converging beam LC (that is, the converging beam LC-2) may be retarded by π/2. The converging beam LC-2 forms a part of the sub-converging beam lc (that is, the sub-converging beam lc-2) after passing through the second phase retardation area 123ar-2, and the sub-converging beam lc-2 is a circular polarization beam. When a part of the converging beam LC (that is, the converging beam LC-3) passes through the third phase retardation area 123ar-3, since the third phase retardation area 123ar-3 is a quarter-wave plate, the phase of the part of the converging beam LC (that is, the converging beam LC-3) may be retarded by π/2. The converging beam LC-3 forms a part of the sub-converging beam lc (that is, the sub-converging beam lc-3) after passing through the third phase retardation area 123ar-3, and the sub-converging beam lc-3 is a circular polarization beam. Since the fast axis direction A3 of the third phase retardation area 123ar-3 is orthogonal to the fast axis direction A2 of the second phase retardation area 123ar-2, although the phases of the converging beams LC-2 and LC-3 are both retarded by π/2, and the formed sub-converging beams lc-2 and lc-3 are both circular polarization beams, the rotational direction of the sub-converging beam lc-3 is opposite to the rotational direction of the sub-converging beam lc-2. When another part of the converging beam LC (that is, the converging beam LC-4) passes through the inactive area 123an, since the inactive area 123an does not have any phase adjustment function, a part of the sub-converging beam lc (that is, a sub-converging beam lc-4) formed after passing through the inactive area 123an is still a linear polarization beam with the same polarization direction as the converging beam LC.

In summary, after the converging beam LC passes through the above four regions (that is, the first phase retardation area 123ar-1, the second phase retardation area 123ar-2, the third phase retardation area 123ar-3, and the inactive area 123an), the sub-converging beams lc-1, lc-2, lc-3, and lc-4 with different phases may be obtained. The sub-converging beams lc-1, lc-2, lc-3, and lc-4 with different phases are split into different second sub-beams lc′ via the second microlens array element 124, and the second sub-beams lc′ are then superimposed into the illumination beam L1 via the second lens element 125. Since the illumination beam L1 is superimposed from the second sub-beams lc′ with different phases, a speckle distribution with slight brightness changes caused by interference between the second sub-beams lc′ may be reduced, thereby improving the comfort of viewing images.

Other embodiments will be listed below to explain the disclosure in detail, wherein the same components will be marked with the same numerals, and the description of the same technical content will be omitted. For the omitted part, please refer to the above embodiment, which will not be reiterated below.

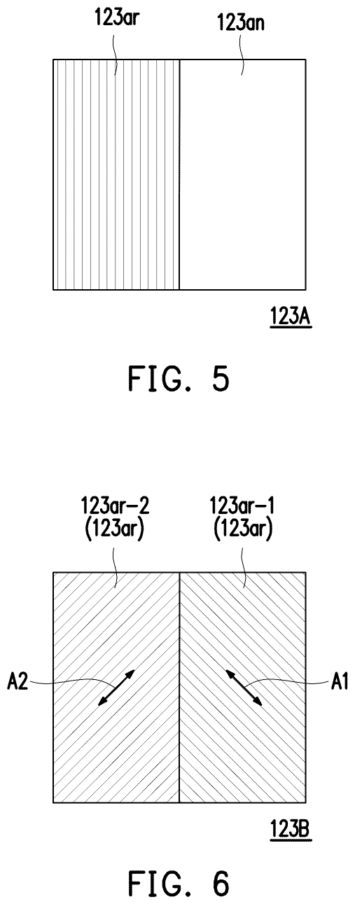

FIG. 5 is a schematic diagram of a phase adjustment element according to another embodiment of the disclosure. Please refer to FIG. 5. A phase adjustment element 123A may include a phase retardation area 123ar and an inactive area 123an. In the embodiment, the phase retardation area 123ar of the phase adjustment element 123A is a half-wave plate, and the inactive area 123an of the phase adjustment element 123A may be a substrate without any phase retardation value, such as but not limited to glass. In some embodiments, the phase retardation area 123ar may be a quarter-wave plate, but the disclosure is not limited thereto. In the embodiment, the number of the phase retardation area 123ar is 1, and the number of the at least part of the sub-converging beams 1c generated after the converging beam passes through the phase retardation areas 123ar is also 1.

The phase adjustment element 123A of FIG. 5 may be used to replace the phase adjustment element 123 of the light source module 10 of FIG. 1. Another light source module and another projection device constructed in such a manner are also within the scope of the disclosure.

FIG. 6 is a schematic diagram of a phase adjustment element according to yet another embodiment of the disclosure. Please refer to FIG. 6. In the embodiment, a phase adjustment element 123B includes two phase retardation areas 123ar and does not include any inactive area. In the embodiment, the phase retardation area 123ar of the phase adjustment element 123B may include a first phase retardation area 123ar-1 and a second phase retardation area 123ar-2. The first phase retardation area 123ar-1 and the second phase retardation area 123ar-2 respectively have phase retardation values and fast axis directions A1 and A2. The phase retardation value of the first phase retardation area 123ar-1 is different from the phase retardation value of the second phase retardation area 123ar-2 and/or the fast axis direction A1 of the first phase retardation area 123ar-1 is different from the fast axis direction A2 of the second phase retardation area 123ar-2. In the embodiment, the first phase retardation area 123ar-1 and the second phase retardation area 123ar-2 are, for example, both quarter-wave plates, and the fast axis direction A1 of the first phase retardation area 123ar-1 and the fast axis direction A2 of the second phase retardation area 123ar-2 are different. The fast axis direction A1 of the first phase retardation area 123ar-1 is orthogonal to the fast axis direction A2 of the second phase retardation area 123ar-2. In some embodiments, the phase retardation value of the first phase retardation area 123ar-1 is different from the phase retardation value of the second phase retardation area 123ar-2, the first phase retardation area 123ar-1 is, for example, a half-wave plate, and the second phase retardation area 123ar-2 is, for example, a quarter-wave plate.

The phase adjustment element 123B of FIG. 6 may be used to replace the phase adjustment element 123 of the light source module 10 of FIG. 1. Another light source module and another projection device constructed in such a manner are also within the scope of the disclosure.

In addition, the number of the phase retardation area 123ar and/or the number of the inactive area 123an are not limited to the content exemplified above. Also, the arrangement manners of the phase retardation area 123ar and/or the inactive area 123an on the light incident surface 123a of the phase adjustment element 123 are also not limited to the content exemplified above.

Based on the above, the disclosure may reduce the position precision requirement of the phase adjustment element by disposing the phase adjustment element on the transmission path of the converging beam, thereby increasing the assembly margin. At the same time, the speckles are reduced to provide the projection image with good homogeneity.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be configured to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light source module, configured to provide an illumination beam, comprising:
a light emitting module, comprising at least one light emitting element, wherein each of the at least one light emitting element is configured to provide a polarization beam; and
a light homogenizing module, configured to homogenize the polarization beams, and generate the illumination beam, wherein along a light travelling direction, the light homogenizing module sequentially comprises:
a first microlens array element;
a first lens element;
a phase adjustment element;
a second microlens array element; and
a second lens element, wherein
the first microlens array element is configured to receive the polarization beams, and homogenize the polarization beams to form a plurality of first sub-beams,
the first lens element is disposed on transmission paths of the first sub-beams and is configured to converge the first sub-beams, wherein the first sub-beams are converged by the first lens element to form a converging beam after passing through the first lens element,
the phase adjustment element is disposed on a transmission path of the converging beam, wherein the converging beam generates a plurality of sub-converging beams after passing through the phase adjustment element, wherein at least part of the sub-converging beams has a different phase from the converging beam,
the second microlens array element is disposed on transmission paths of the sub-converging beams and is configured to homogenize the sub-converging beams to form a plurality of second sub-beams, and
the second lens element is disposed on transmission paths of the second sub-beams and is configured to converge the second sub-beams, wherein the second sub-beams are converged by the second lens element to form the illumination beam after passing through the second lens element.

2. The light source module according to claim 1, wherein the second microlens array element has a light incident surface configured to allow the sub-converging beams to enter, and a focal plane of the first lens element is substantially located on the light incident surface of the second microlens array element.

3. The light source module according to claim 2, wherein the phase adjustment element is substantially disposed on the light incident surface of the second microlens array element.

4. The light source module according to claim 2, wherein the phase adjustment element is located between the first lens element and the second microlens array element, and is disposed close to the light incident surface of the second microlens array element and away from the first lens element.

5. The light source module according to claim 1, wherein the phase adjustment element is a stationary member.

6. The light source module according to claim 1, wherein the phase adjustment element has a light incident surface configured to allow the converging beam to enter, wherein the light incident surface of the phase adjustment element has at least one phase retardation area configured to allow at least part of the converging beam to enter, and to retard a phase of the at least part of the converging beam to generate the at least part of the sub-converging beams.

7. The light source module according to claim 6, wherein a number of the at least one phase retardation area is plural, a speckle formed by the converging beam on the light incident surface of the phase adjustment element overlaps with at least part of each of the phase retardation areas, and a number of the at least part of the sub-converging beams generated after the converging beam passes through the phase retardation areas is the same as the number of the phase retardation areas.

8. The light source module according to claim 6, wherein the at least one phase retardation area comprises a first phase retardation area and a second phase retardation area, wherein the first phase retardation area and the second phase retardation area respectively have a phase retardation value and a fast axis direction, wherein the phase retardation value of the first phase retardation area is different from the phase retardation value of the second phase retardation area and/or the fast axis direction of the first phase retardation area is different from the fast axis direction of the second phase retardation area.

9. The light source module according to claim 8, wherein the phase retardation value of the first phase retardation area and the phase retardation value of the second phase retardation area are different, the first phase retardation area is a half-wave plate, and the second phase retardation area is a quarter-wave plate.

10. The light source module according to claim 8, wherein the fast axis direction of the first phase retardation area and the fast axis direction of the second phase retardation area are different, the first phase retardation area and the second phase retardation area are both quarter-wave plates, and the fast axis direction of the first phase retardation area is orthogonal to the fast axis direction of the second phase retardation area.

11. The light source module according to claim 8, wherein the at least one phase retardation area further comprises a third phase retardation area, wherein the third phase retardation area has a phase retardation value and a fast axis direction, the phase retardation value of the first phase retardation area and the phase retardation value of the second phase retardation area are different, the phase retardation value of the second phase retardation area and the phase retardation value of the third phase retardation area are the same, there is an included angle between the fast axis direction of the second phase retardation area and the fast axis direction of the third phase retardation area, and the included angle is not 180 degrees.

12. The light source module according to claim 11, wherein the first phase retardation area is a half-wave plate, the second phase retardation area is a quarter-wave plate, the third phase retardation area is a quarter-wave plate, and the fast axis direction of the second phase retardation area is orthogonal to the fast axis direction of the third phase retardation area.

13. The light source module according to claim 6, wherein the light incident surface of the phase adjustment element further comprises an inactive area configured to allow another part of the converging beam to enter, wherein a speckle formed by the converging beam on the light incident surface of the phase adjustment element overlaps with at least part of the inactive area, and a phase of the another part of the converging beam does not change after passing through the inactive area.

14. A projection device, comprising a light source module, a light valve, and a projection lens, wherein:
the light source module is configured to provide an illumination beam, and the light source module comprises a light emitting module and a light homogenizing module, wherein:
the light emitting module comprises at least one light emitting element, wherein each of the at least one light emitting element is configured to provide a polarization beam; and
the light homogenizing module is configured to homogenize the polarization beams, and generate the illumination beam, wherein along a light travelling direction, the light homogenizing module sequentially comprises:
a first microlens array element;
a first lens element;
a phase adjustment element;
a second microlens array element; and
a second lens element, wherein
the first microlens array element is configured to receive the polarization beams, and homogenize the polarization beams to form a plurality of first sub-beams,
the first lens element is disposed on transmission paths of the first sub-beams and is configured to converge the first sub-beams, wherein the first sub-beams are converged by the first lens element to form a converging beam after passing through the first lens element,
the phase adjustment element is disposed on a transmission path of the converging beam, wherein the converging beam generates a plurality of sub-converging beams after passing through the phase adjustment element, and at least part of the sub-converging beams has a different phase from the converging beam,
the second microlens array element is disposed on transmission paths of the sub-converging beams and is configured to homogenize the sub-converging beams to form a plurality of second sub-beams, and
the second lens element is disposed on transmission paths of the second sub-beams and is configured to converge the second sub-beams, wherein the second sub-beams are converged by the second lens element to form the illumination beam after passing through the second lens element;
the light valve is disposed on a transmission path of the illumination beam and is configured to convert the illumination beam into an image beam; and
the projection lens is disposed on a transmission path of the image beam and is configured to project the image beam out of the projection device.

15. The projection device according to claim 14, wherein the second microlens array element has a light incident surface configured to allow the sub-converging beams to enter, a focal plane of the first lens element is substantially located on the light incident surface of the second microlens array element, and the phase adjustment element is substantially disposed on the light incident surface of the second microlens array element.

16. The projection device according to claim 14, wherein the phase adjustment element is a stationary member.

17. The projection device according to claim 14, wherein the phase adjustment element has a light incident surface configured to allow the converging beam to enter, wherein the light incident surface of the phase adjustment element has at least one phase retardation area configured to allow at least part of the converging beam to enter, and to retard a phase of the at least part of the converging beam to generate the at least part of the sub-converging beams.

18. The projection device according to claim 17, wherein a number of the at least one phase retardation area is plural, a speckle formed by the converging beam on the light incident surface of the phase adjustment element overlaps with at least part of each of the phase retardation areas, and a number of the sub-converging beams generated after the converging beam passes through the phase retardation areas is the same as the number of the phase retardation areas.

19. The projection device according to claim 17, wherein the at least one phase retardation area comprises a first phase retardation area and a second phase retardation area, wherein the first phase retardation area and the second phase retardation area respectively have a phase retardation value and a fast axis direction, wherein the phase retardation value of the first phase retardation area is different from the phase retardation value of the second phase retardation area and/or the fast axis direction of the first phase retardation area is different from the fast axis direction of the second phase retardation area.

20. The projection device according to claim 17, wherein the light incident surface of the phase adjustment element further comprises an inactive area configured to allow another part of the converging beam to enter, wherein a speckle formed by the converging beam on the light incident surface of the phase adjustment element overlaps with at least part of the inactive area, and a phase of the another part of the converging beam does not change after passing through the inactive area.
